(19) United States
(12) Patent Application Publication
(10) Pub. No.: US 2004/0179218 A1
(43) Pub. Date: Sep. 16, 2004

(54) Enhanced print job delivery in a distributed raster image processing environment

(76) Inventor: Paul R. Wissenbach, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/385,383

(22) Filed: Mar. 10, 2003

(51) Int. Cl. G06F 15/00

(52) U.S. Cl. 358/1.13; 358/1.15

(57) ABSTRACT

Systems and methods for enhanced print job delivery in a distributed raster image processing (RIPing) environment are described. The distributed RIPing environment includes, for example, a raster image process (RIP) manager coupled to multiple RIP engines. In one aspect, the RIP manager receives a print job. The RIP manager then multicasts a single copy of the print job across the distributed raster image processing environment to a select group of the multiple RIP engines. The multicasting operation provides each of the select group with access to a respective copy of the print job for RIPing one or more respective portions of the print job.

### TECHNICAL FIELD

The invention pertains to management of network printing resources.

### BACKGROUND

Raster image processing (RIP'ing) is the process of translating digital vector image data into bit-mapped image data or raster bits for rendering. Such vector image data is generally expressed in Page Description Language (PDL) such as Printer Control Language® (PCL), Portable Document Format® (PDF), or PostScript® (PS). In the printing field, one or more hardware and/or software implemented raster image process (RIP) engines are commonly used by print shops to RIP large print jobs or documents for printing on a printing press. When one or more RIP resources, which may be implemented across any number of computing devices, are configured to work on a particular print job, the RIP resources are collectively referred to as a pipeline.

When configuring a pipeline to RIP a print job that has been partitioned into multiple parts, each RIP engine in the pipeline is typically required to obtain a copy of the print job for reference. To this end, a centralized RIP manager typically distributes multiple copies of the print job across the network; one copy per RIP engine in the pipeline. For instance, if a RIP pipeline consists of ten (10) RIP engines, 10 copies of the print job must be distributed across the network.

Print jobs can be quite large, representing hundreds, thousands, and even tens of thousands of pages of print data. In light of this, communicating multiple copies of a print job across the network to configure multiple RIP engines to work in unison on the print job may take a substantial amount of time to complete. Moreover, such serial print job downloading/uploading operations can consume considerable amounts of a network's bandwidth. When this happens, network throughput is adversely affected, possibly causing network processes and/or network resources to slow down and even become unavailable.

The following systems and procedures address these and other problems of existing techniques to load multiple RIP engines of a pipeline with a respective print job copy.

### SUMMARY

Systems and methods for enhanced print job delivery in a distributed raster image processing (RIPing) environment are described. The distributed RIPing environment includes, for example, a raster image process (RIP) manager coupled to multiple RIP engines. In one aspect, the RIP manager receives a print job. The RIP manager then multicasts a single copy of the print job across the distributed raster image processing environment to a select group of the multiple RIP engines. The multicasting operation provides each of the select group with access to a respective copy of the print job for RIPing one or more respective portions of the print job.

### BRIEF DESCRIPTION OF THE DRAWINGS

The detailed description is described with reference to the accompanying figures.

FIG. 1 is an exemplary suitable computing environment within which enhanced delivery of a print job in a distributed raster image processing environment may be implemented.

FIG. 2 shows an exemplary procedure to deliver of a print job in a distributed raster image processing environment.

### DETAILED DESCRIPTION

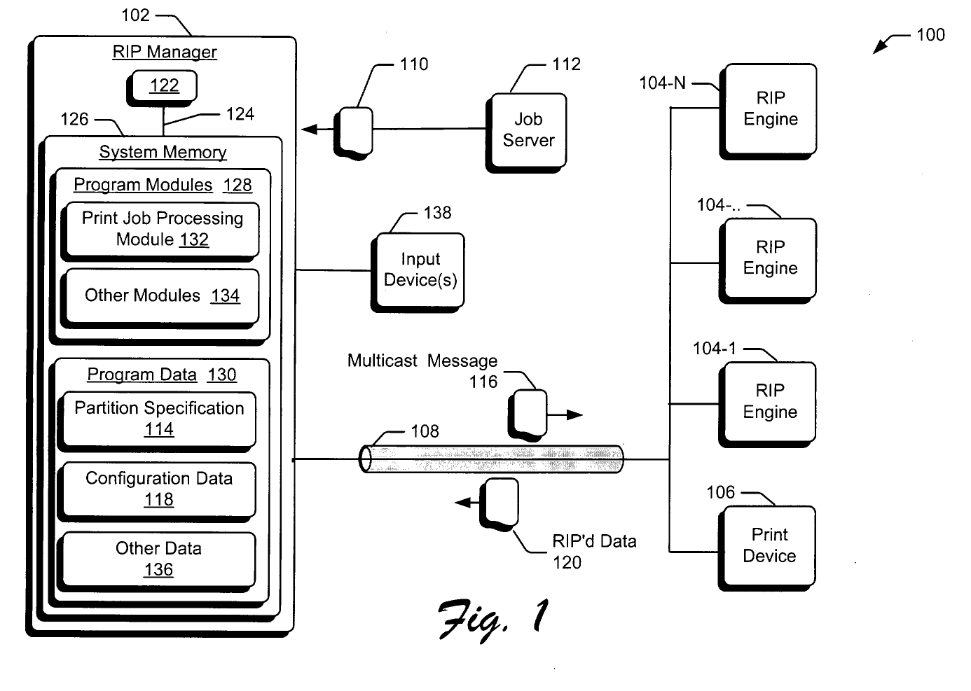

Turning to the drawings, wherein like reference numerals refer to like elements, the invention is illustrated as being implemented in a suitable computing environment. FIG. 1 is an exemplary suitable computing environment 100 within which systems, apparatuses and methods to enhance print job delivery in a distributed RIP engine environment may be implemented. Exemplary computing environment 100 is only one example of a suitable computing environment and is not intended to suggest any limitation as to the scope of use or functionality of systems and methods the described herein.

Although not required, the invention will be described in the general context of computer-executable instructions, such as program modules executed in a distributed computing environment by a computer. Program modules generally include routines, programs, objects, components, data structures, etc., that perform particular tasks or implement particular abstract data types. In a distributed computing environment, program modules may be located in both local and remote memory storage devices.

As shown in FIG. 1, the exemplary computing environment 100 includes RIP manager 102, one or more RIP engines 104-1 through 104-N, and one or more print device(s) 106. The RIP manager is coupled to these other components over communication path 108. The communication path represents any type of physical or wireless network communication infrastructure deployed, for example, as an organizational Intranet.

The RIP manager 102 receives a print job 110 from a job server 112. The print jobs include, for example, print data to be rendered onto the printing device 106. Since print data is typically expressed in a Page Description Language (PDL) and vector image data, the print data is transcoded into bitmapped data before being printed on the print device 106. To this end, the RIP manager divides the print data into multiple partitions. A partition is a number of pages of the print job. The pages in any one partition may be consecutive or non-consecutive.

Once the partitions are known, the RIP manager creates a partition specification 114 to keep track of the RIPing completion status of each of the partitions. (Such a completion status is later used to determine when all of the partitions have been RIP'd so they can be aggregated for printing). The RIP manager assigns one or more respective partitions to each of one or more of the RIP engines 104-1 thorough 104-N. Partition assignment(s) may be based on any number of different criteria such as RIP engine availability, partition size, current and/or anticipated print shop workflow, and so on. Respective RIP engine RIPing assignments are mapped in the partition specification to corresponding ones of the partitions.

The RIP manager communicates the RIP job using multicast messages 116 to a multicast group to which the selected group of the RIP engines 104-1 thorough 104-N have subscribed. Such communication or packet transmission is referred to as multicasting. In combination, the multicast message(s) encapsulate only a single copy of the print job 110, and optionally also encapsulate a single copy of the partition specification 114. In practice, the entire print job will be split up and sent in a series of multicast packets. Such a series is often represented herein as a single multicast message. In this implementation, the group of recipients is the group of RIP engines that were each assigned to RIP at least one respective partition of the print job 110. The multicast group is subscribed to by respective ones of the RIP engines and is managed by an administrative entity and maintained as configuration data 118.

At least a subset of the RIP engines 104-1 through 104-N (i.e., those assigned to RIP at least one respective partition of the print job 110) receive the multicast message 116. Responsive to receiving the multicast message, each RIP engine of the at least a subset of RIP engines will process/RIP one or more partitions of the print job as directed by the partition specification 114. Once the print data specified by the print job has been raster image processed (RIP'd) by respective ones of the RIP engines, RIP'd data 120 (in bitmap form) is communicated back to the RIP manager for aggregation and subsequent communication to the print device 106 for printing.

Recall that conventional systems that distribute print jobs to multiple RIP engines require a substantial amount of time to send a respective copy of a print job to each of the multiple RIP engines in a pipeline. That is, the copy operations require multiple transmissions of the same print job data; one print job transmission per RIP engine in the pipeline. Thus, conventional systems require a total amount of time to download a print job to each of the RIP engines in a pipeline such that the total amount of download time is a direct function of the number of RIP engines in the pipeline. That is, download time=(file size*RIP engine count)/network transmission speed.

In contrast to such conventional systems, the RIP manager 102 utilizes multicast message 116 to communicate a single copy of the print job 110 and the partition specification 114. Each of the multiple RIP engines 104-1 through 104-N will obtain a respective copy of the partition specification and print job from the single transmitted copy. The total amount of time to transmit the single copy of the print job and partition specification is not a function of the number of RIP engines that are designated (selected, or registered) to receive the print job. Rather, the total transmit time=(multicast message size)/network transmission speed. Thus, the RIP manager 102 provides each of multiple RIP engines with a copy of the print job in a manner that is completely independent of whether one (1), one-hundred (100), one-thousand (1000), etc., RIP engines are designated to receive the print job. The total transmit time is going to be the same whether 1, 100, 1000, etc., RIP engines are being sent the print job. Because of this, the described system 100, as compared to what is typically experienced in traditional print shop environments, reduces print job transfer latencies, improves utilization of network resources (e.g., the RIP manager), and reduces network bandwidth data throughput requirements.

In one implementation, the RIP manager transmits the multicast message 116 using a reliable communication protocol such as the known Extensible Transport Protocol (XTP). This is to substantially guarantee that each selected RIP engine 104-1 through 104-N in a pipeline will receive the print job 110 encapsulated in the multicast message.

Exemplary RIP Manager Components

The RIP manager 102 includes, for example, a processor 122 coupled across a bus 124 to a system memory 126. The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

System memory 126 includes a variety of computer readable media. Such media may be any available media that is accessible by RIP manager 102, and it includes both volatile and non-volatile media, removable and non-removable media. In particular, the system memory includes computer-readable media in the form non-volatile memory, such as read-only memory (ROM), and/or volatile memory, such as random access memory (RAM). The RIP manager may further include other removable/non-removable, volatile/non-volatile computer storage media (not shown) such as a hard disk drive, a CD-ROM, a magnetic tape drive, and so on.

The RAM portion of the system memory 126 contains program modules 128 and program data 130 that are immediately accessible to and/or presently being operated on by the processor 122. For instance, the program modules include print job processing module 132 and other modules 134 such as an operating system (OS) to provide a runtime environment, a RIP resource pipeline configuration routine, and/or the like. The program data includes, for example, print job 110, partition specification 114, configuration data 118, RIP'd data 120, and other data 136 such as print shop workflow scheduling data, or the like.

A user may provide commands and information into the RIP manager 102 through one or more input devices 138 such as a keyboard and pointing device such as a “mouse”. Other input devices may include a microphone, joystick, game pad, satellite dish, serial port, scanner, camera, etc. These and other input devices are connected to the processing unit 122 through an input interface (not shown) coupled to the bus 124, but may be connected by other interface and bus structures, such as a parallel port, game port, or a universal serial bus (USB). Optionally, the RIP manager may also be coupled to a monitor (not shown).

An Exemplary Procedure

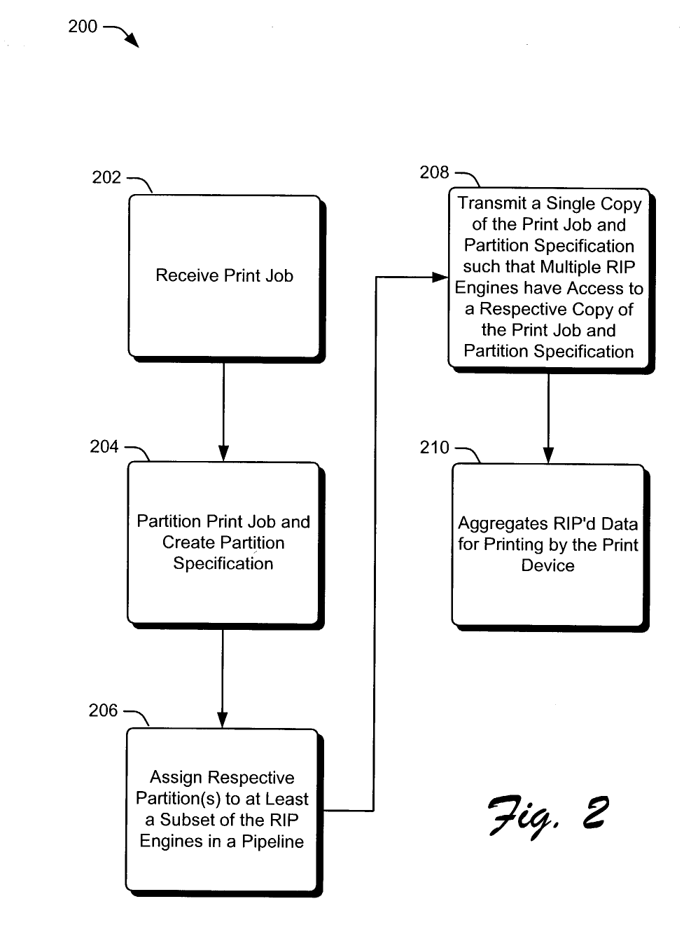

FIG. 2 shows an exemplary procedure 200 to for a RIP manager to enhance print job delivery in a distributed RIP engine environment. For purposes of discussion, the exemplary procedure is described in reference to features of FIG. 1. At block 202, the print job processing module 132 (FIG. 1) of the RIP manager 102 receives a print job 110. At block 204, the print job processing module 132 partitions the print job and creates the partition specification 114 (FIG. 1). At block 206, the print job processing module 132 assigns respective partition(s) to at least a subset of the RIP engines 104-1 through 104-N (FIG. 1). For purposes of discussion, the RIP engines, in the at least a subset, are referred to as designated RIP engines. At block 208, print job processing module 132 transmits a single copy of the print job and the partition specification to the designated RIP engines (i.e., a selected group of RIP engines) via multicast message(s) 116 (FIG. 1). This single copy transmission provides the print job and the partition specification to each of the disignate RIP engines. At block 210, as the designated RIP engines complete their respective RIPing operations and send corresponding RIP'd data 120 (FIG. 1) to the RIP manager, the print job processing module 132 aggregates the RIP'd data for printing by the print device 106 (FIG. 1).

Conclusion

The described systems and methods enhance print job delivery in a distributed RIP engine environment. Although the systems and methods have been described in language specific to structural features and methodological operations, the subject matter as defined in the appended claims are not necessarily limited to the specific features or operations described. Rather, the specific features and operations are disclosed as exemplary forms of implementing the claimed subject matter.

1. A method for enhanced print job delivery in a distributed raster image processing environment including a raster image process (RIP) manager coupled to multiple RIP engines and a print device, the method comprising:
receiving, by the RIP manager, a print job; and
multicasting, by the RIP manager, a single copy of the print job across the distributed raster image processing environment to a select group of the multiple RIP engines such that each of the select group obtains a respective copy of the print job for RIPing one or more respective portions of the print job.

2. A method as recited in claim 1, wherein the select group comprises one or more of the multiple RIP engines.

3. A method as recited in claim 1, wherein multicasting further comprises communicating a set of multicast messages that in total encapsulate the print job, and such that a total amount of time to communicate the print job to each RIP engine in the select group is independent of how many RIP engines are in the select group.

4. A method as recited in claim 1, wherein multicasting further comprises communicating a set of multicast messages that encapsulate a single copy of the print job such that a total amount of time to transmit the print job to each RIP engine in the select group is only a function of print job size and network transmission speed.

5. A method as recited in claim 1, wherein multicasting further comprises communicating a set of multicast messages that encapsulate a single copy of the print job using a communication protocol that substantially guarantees that each of the select group will receive the multicast message.

6. A method as recited in claim 1, wherein the method further comprises:
dividing the print job into a plurality of partitions; and
for each partition of the partitions:
assigning the partition to a particular one of the select group for RIPing; and
indicating in the print job that the particular one is assigned to RIP the partition.

7. A computer-readable medium for enhanced print job delivery in a distributed raster image processing environment including a raster image process (RIP) manager coupled to multiple RIP engines and a print device, the computer-readable medium comprising computer-program instructions executable by a processor for:
receiving, by the RIP manager, a print job;
generating, by the RIP manager, a set of multicast messages that encapsulate a single copy of the print job; and
transmitting, by the RIP manager, the multicast messages to a select group of the multiple RIP engines such that each of the select group is provided with access to the print job for RIPing one or more respective portions of the print job.

8. A computer-readable medium as recited in claim 7, wherein the select group comprises one or more of the multiple RIP engines.

9. A computer-readable medium as recited in claim 7, wherein the computer-program instructions for transmitting further comprise instructions for communicating the multicast messages such that a total amount of time to multicast the print job to each RIP engine in the select group is independent of how many RIP engines are in the select group.

10. A computer-readable medium as recited in claim 7, wherein the computer-program instructions for transmitting further comprise instructions for communicating the multicast messages such that a total amount of time to provide the print job to each RIP engine in the select group is only a function of print job size and network transmission speed.

11. A computer-readable medium as recited in claim 7, wherein the computer-program instructions for transmitting further comprise instructions for communicating the multicast messages using a communication protocol that substantially guarantees that each of the select group will receive the multicast message.

12. A computer-readable medium as recited in claim 7, further comprising computer-program instructions for:
dividing the print job into a plurality of partitions; and
for each partition of the partitions:
assigning the partition to a particular one of the select group for RIPing; and
indicating in the print job that the particular one is assigned to RIP the partition.

13. A raster image process (RIP) manager computing device for enhanced print job delivery in a distributed raster image processing environment, the RIP manager being configured for coupling to multiple RIP engines and a print device, the RIP manager computing device comprising:
a processor; and
a memory coupled to the processor, the memory comprising computer-program instructions executable by the processor for:
receiving, by the RIP manager, a print job;
generating, by the RIP manager, a set of multicast messages that encapsulate a single copy of the print job; and
transmitting, by the RIP manager, the multicast messages to a select group of the multiple RIP engines such that each of the select group obtains a respective copy of the print job for RIPing one or more respective portions of the print job.

14. A RIP manager as recited in claim 13, wherein the computer-program instructions further comprise instructions for distributing a single copy of a partition specification across the multicast messages for delivery with the print job to the select group, the partition specification indicating respective RIP engine RIPing assignments.

15. A RIP manager as recited in claim 13, wherein the select group comprises one or more of the multiple RIP engines.

16. A RIP manager as recited in claim 13, wherein the computer-program instructions for transmitting further comprise instructions for communicating the multicast messages such that a total amount of time to multicast the print job to each RIP engine in the select group is independent of how many RIP engines are in the select group.

17. A RIP manager as recited in claim 13, wherein the computer-program instructions for transmitting further comprise instructions for communicating the multicast messages such that a total amount of time to provide the print job to each RIP engine in the select group is only a function of print job size and network transmission speed.

18. A RIP manager as recited in claim 13, wherein the computer-program instructions for transmitting further comprise instructions for communicating the multicast messages using a communication protocol that substantially guarantees that each of the select group will receive the multicast message.

19. A RIP manager as recited in claim 13, further comprising computer-program instructions for:
dividing the print job into a plurality of partitions; and
for each partition of the partitions:
assigning the partition to a particular one of the select group for RIPing; and
indicating in the print job that the particular one is assigned to RIP the partition.

20. A raster image process (RIP) manager for enhanced print job delivery in a distributed raster image processing environment, the RIP manager being configured for coupling to multiple RIP engines and a print device, the RIP manager computing device comprising:
means for receiving a print job;
means for multicasting, by the RIP manager, a single copy of the print job across the distributed raster image processing environment to a select group of the multiple RIP engines such that each of the select group obtains a respective copy of the print job for RIPing one or more respective portions of the print job.

21. A RIP manager computing device as recited in claim 20, wherein the means for multicasting further comprise means for communicating the multicast messages such that a total amount of time to provide each RIP engine in the select group with access to the print job is independent of how many RIP engines are in the select group.
